(19) United States
(12) Patent Application Publication
(10) Pub. No.: US 2006/0283684 A1
(43) Pub. Date: Dec. 21, 2006

(54) Centrifugal drum clutch assembly and method of manufacture

(76) Inventor: Thomas Beerens, Melbourne (AU)

Correspondence Address: Tony Crisafi, 20 Renown Street, Bentleigh, 3204, AU

(21) Appl. No.: 10/568,576

(22) PCT Filed: Jul. 13, 2005
(86) PCT No.: PCT/AU05/01020

§ 371 Date: Feb. 17, 2006

(30) Foreign Application Priority Data
Jul. 14, 2004 (AU) 2004903839

(51) Int. Cl. F16D 13/62; F16D 43/18

(52) U.S. Cl. 192/107 T; 192/103 B

(57) ABSTRACT

A clutch drum assembly comprising a clutch drum (21) and a drive means. The clutch drum (21) has an axis of rotation and includes an end wall (22). The drive means specifically a drive spline (1) or a fixed drive sprocket axially to one end of drive means, is a flange (5) with one or more radial evenly spaced minimally sized apertures (6) that have been counter sunk or counter bored to one side. Unitary axial motion of the two components is achieved via a mechanical connection between the two said components by tightly pressing metal from the outer surface of the end wall (22) clutch through each of the minimally sized apertures (6) in the drive means flange (5) against a die positioned proximate to each said aperture (6) forging the metal into the counter sunk or counter bored portion of the drive means flange (5).

### FIELD OF THE INVENTION

This invention generally relates to centrifugal clutches and more particularly to improvements in the method by which the drive means is permanently fixed to the clutch drum.

### BACKGROUND OF THE INVENTION

Drive devices such as centrifugal clutches are widely used to transmit torque from an engine or motor to a user device. The centrifugal clutch art in this respect is well developed with centrifugal clutch devices being used in smaller vehicles like go karts and motor bikes and tools like chainsaws, brush cutters and flexible cable grass cutters.

This invention relates to drive device assemblies that include a clutch drum and one of various drive means that may be coupled to the clutch drum including a fixed drive sprocket, a drive spline or a drive shaft; where a fixed drive sprocket directly drives a user device; a drive spline drives a user device indirectly with the addition of a replaceable drive sprocket; and a drive shaft drives a user device indirectly with the addition of a drive sprocket, a drive pulley, a drive cable or a drive shaft.

The broad use of clutch drum assemblies in various sizes and configurations depending on application has resulted in a diverse number of approaches to the manufacture of the clutch drum assemblies and associated costs, each approach having favorable and unfavorable aspects. In relation to this, it has been established historically that for technical and economic reason the most cost effective means of manufacturing the clutch drum assembly is to manufacture the clutch drum and the drive means separately with the desired engineering characteristics and then coupling the two components together in the most cost effective way.

The method used to couple the clutch drum and drive means is critical as the amount of torque that may be transferred from the clutch drum to the drive means is limited by the quality and strength of the connection. The most common approach to couple the two components together is to use a brazing technique while another approach is to use a mechanical connection. Irrespective of which approach is used, the connection must be reliable preventing warranty claims and repairs while also being cost effective to manufacture.

The desire to couple the drive means to the clutch drum in an extremely efficient and cost effective manner while retaining the torque strength of the connection is extremely desirable as it enables the manufacturer to have a competitive advantage and has resulted in the disclosure of numerous approaches however none to date have provided a simple approach that is universally applicable to this type of connection and satisfies the criteria of being cost effective and efficient to manufacture while being robust and reliable in use.

The need to satisfy these requirements is illustrated by referring to prior publications outlining proposals of alternative approaches recommended to overcome some of the obstacles inherent in a clutch drum assembly.

U.S. Pat. No. 4,984,669 discloses a clutch drum assembly for a centrifugal clutch whose parts can be assembled by expedient brazing operations, and which can be made mostly of relatively inexpensive materials which do not require heat treatment, and provide exceptionally cheap parts where hardness is needed. In this invention the drive means is brazed to the clutch drum at temperatures which do not tend to warp the drum, the drive means extending axially away from the clutch drum. A recess formed in the free end of the drive means shaft accepts a series of hardened washers with serrated outer edges that dig into the recess wall. Each washer has a non circular port through so that a plurality of washers when aligned and pressed into the drive means recess assure concentricity. This improved product is cheaper to produce however the use of less expensive materials for the clutch drum and drive means may be unreliable in larger devices requiring significantly higher torque output; furthermore the device is not adaptable to arrangements where a drive spline or sprocket is required.

U.S. Pat. No. 5,636,935 discloses a mechanical connection between a clutch drum and the drive means, In this invention the drive means is a drive sprocket with radially spaced axial projections on each tooth of the fixed drive sprocket. The mechanical connection is formed by pressing together the clutch drum and the drive sprocket, the projections of the drive means being used as a punch tool to create the apertures in the end wall of the clutch drum during assembly. If desired the clutch drum and drive means my additionally be brazed together to give added strength to the device. This improved device has very high torsion and lateral strength however, the manufacturing process involves several steps and consequently is a relatively expensive clutch drum and drive means assembly to manufacture in comparison to previously more inferior assemblies that may not be as reliable or have equivalent torsion strength.

Other prior disclosures utilise variations on the above arrangements in an attempt to address the stated requirements however none appear to be able to achieve the objectives in a truly efficient and cost effective manner while being universally applicable to this type of connection between a clutch drum and drive means.

### SUMMARY OF THE INVENTION

According to an object of the present invention there is provided a clutch drum assembly comprising a clutch drum and drive means, wherein the assembly of the two components has been streamlined resulting in significant cost savings and increased production output.

According to another object of the present invention there is provided a clutch drum assembly comprising a clutch drum and drive means wherein the design of the individual components has been simplified in such a manner as to reduce their manufacturing cost and facilitate the said streamlined assembly.

Yet another object of the present invention is to provide the said efficiencies and said cost savings without sacrificing any of the said robust and reliability requirements.

These and other objectives are attained with a clutch drum assembly comprising a clutch drum and drive means mounted thereon. The clutch drum defines an axis of rotation and includes an end wall forming one central aperture. The drive means may be one of several different embodiments specifically a drive spline or a fixed drive sprocket that is axially bored for joumaling on a suitable shaft or the drive means may be a solid drive shaft that is joumaled to a housing by a bearing. Axially to one end of each of these drive means is a flange with one or more radial evenly spaced minimally sized apertures that have been counter sunk or counter bored to one side. A spigot on the splined side of the flange is used for mating with the central aperture in the end wall of the clutch drum when the drive means is inserted through the clutch drum. Upon mating of the two members, the assembly is fixed together by pressing metal from the end wall of the clutch drum through each of the minimally sized apertures on the drive means flange by using a blunted or stepped punching device, a plurality of such devices arranged radially around the drum assembly in registration with the minimally sized apertures in the drive means flange, enabling the operation to be performed in one action. The metal pushed through the minimally sized apertures in the drive means flange is pressed against a die and is forged into the shape of the counter sunk or counter bored portion of the minimally sized apertures in the drive means flange proximate to the die securing the two members together somewhat analogous to the function performed by a rivet.

Preferably, the drive means is inserted within the clutch drum so that the drive means flange is flush with the inside wall of the clutch drum and the drive means spline projects axially through the end wall opening of the clutch drum. In another embodiment, the drive means may be assembled with the drive means flange to the outside of the clutch drum.

In a preferred method of forming the centrifugal clutch device assembly, the clutch drum and drive means are mechanically connected in a single step using a blunted or two step punch tool with an equal number of axial protrusions as there are apertures in the drive means flange. The blunted two step or punch tool being used to press the metal from the end wall of the clutch drum through minimally sized apertures in the drive means flange, and on passing through the said minimally sized apertures, the metal of the end wall of the clutch drum expands to fill a cavity of greater size than the said minimally sized apertures forming the mechanical connection.

Further benefits and advantages of the invention will become apparent from a consideration of the following detailed description given with reference to the accompanying drawings, which specify and show preferred embodiments of the invention:

### BRIEF DESCRIPTION OF THE DRAWINGS

FIG. 1 shows a perspective view of the clutch drum and drive means of the clutch drum assembly in this invention in a disassembled condition;

FIG. 2 shows a perspective view of the clutch drum assembly with the internal detail clearly visible;

FIG. 3 shows a perspective view of the clutch drum assembly with the external front detail clearly visible;

FIG. 4 shows a frontal elevation view of the clutch drum assembly;

FIG. 5 shows a rear elevation view of the clutch drum assembly;

FIG. 6 shows a sectional view of the clutch drum assembly taken along line AA of FIG. 4.

FIG. 7 shows a sectional view of an alternative embodiment of the clutch drum assembly;

### DETAILED DESCRIPTION OF INVENTION

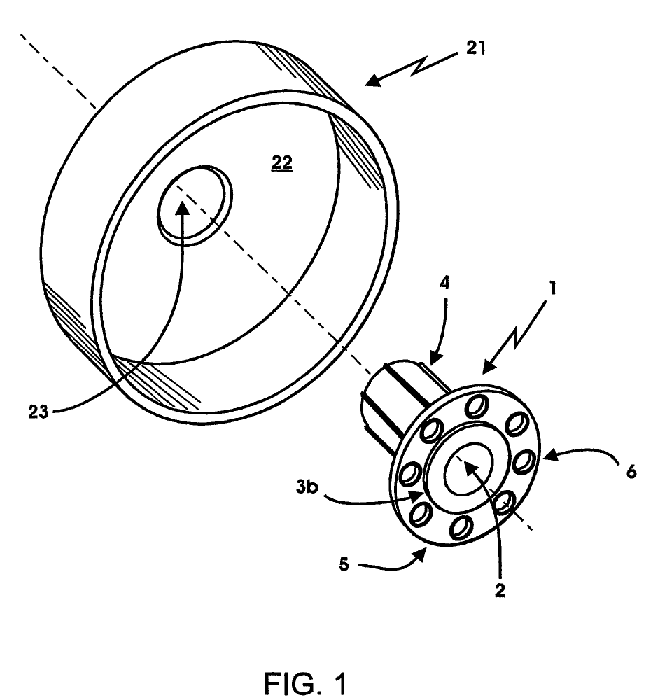

A particularly preferred embodiment of the invention and method for assembly will now be discussed with reference to FIGS. 1 to 6.

In FIG. 1 is provided a drive spline 1 with a through bore 2, a rear spigot 3b, an axial splined extension 4 and a flange 5. Said flange 5 is provided with one or more substantially similar and minimally sized apertures 6 that are counter sunk or counter bored to the side opposite the axial splined extension 4 and are reasonably evenly located radially around the flange 5. A clutch drum 21 has an end wall 22 and a centrally located aperture 23.

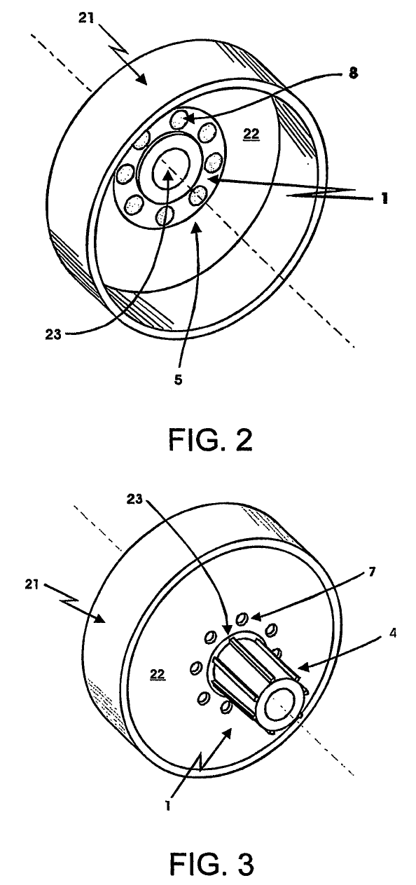

When assembled the clutch drum assembly, FIG. 2 and FIG. 3, show the axial splined extension 4 of the drive spline 1 inserted through the centrally located aperture 23 of the end wall 22 of the clutch drum 21. Metal depressions 7 created in the exterior end wall 22 of the clutch drum 21 in line with the minimally sized apertures 6 in the flange 5 project through the minimally sized apertures 6 in the flange 5 and are forged into the shape of the counter sink or counter bore 8 on the other side of the drive means flange 5 within the interior of the clutch drum 21 forming the mechanical connection between the clutch drum 21 and the drive spline 1 that enables unitary rotation about a central axis of the clutch drum assembly.

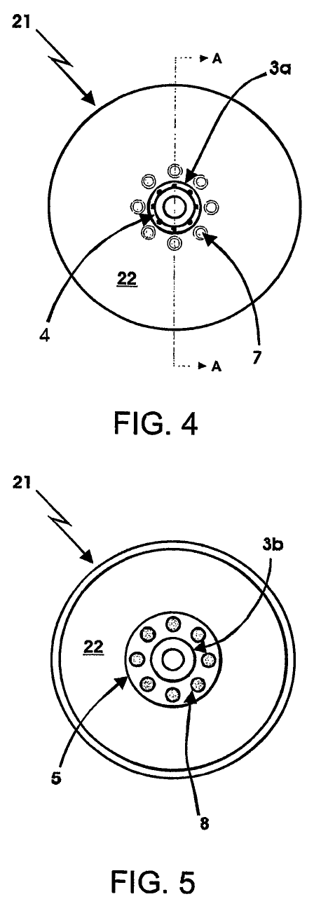

FIG. 4 is a frontal elevation showing the exterior of the clutch drum 21, the axial splined extension 4, the front spigot 3a, the depressions 7 on the outside end wall 22 of the clutch drum 21 in line with the apertures 6 of the flange 5.

FIG. 5 is a rear elevation showing the interior of the clutch drum 21, the flange 5, the spigot 3b and the clutch drum 21. Metal 8 from the clutch drum end wall 22 is forged into the shape of the counter sink or counter bore in each of the minimally sized apertures 6 located radially about the flange 5.

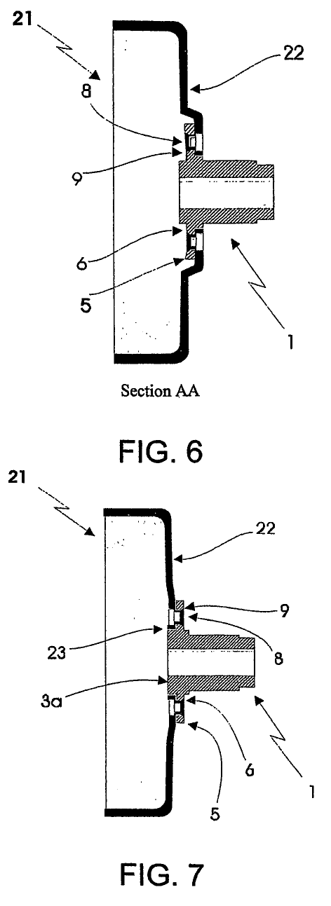

FIG. 6 shows a section along line AA of the clutch drum assembly FIG. 4. Clearly visible is the metal 8 that has been pressed from the outside end wall 22 of the clutch drum 21, with the aid of an appropriately sized stepped or blunted punching device, through the minimally sized apertures 6 of the flange 5 and forged into the shape of the counter sunk or counter bored portions 9 of the minimally sized apertures 6 that abut a die forming an enclosure, and one or more of such connections resulting in the creation of a robust mechanical connection not requiring any brazing between the clutch drum 21 and the drive spline 1.

A particularly preferred method of formation of the clutch drum assembly is for the drive spline 1 to be inserted through the centrally located aperture 23 of the end wall 22 of the clutch drum 21, receiving the inner spigot 3a and with the flange 5 of the drive spline 1 positioned within a recessed section 24 of the clutch drum end wall 22 such that the end spigot 3b of the drive spline 1 is flush with the inside end wall 22 of the clutch drum 21. A punch tool comprising one or more axially projecting and radially arranged stepped or blunted punches in registration with the apertures 6 of the flange 5 is then used to press metal 8 from the outside end wall 22 of the clutch drum 21 through minimally sized apertures 6 of the flange 5 forging the metal 8 into the shape of the counter sunk or counter bored portions 9 of the apertures 6 abutting a die forming an enclosure.

Other embodiments of the clutch drum assembly are possible as shown in FIG. 7 where the drive spline 1 has been attached to the outer of the clutch drum 21 end plate 22 with the central aperture 23 of the end wall 22 receiving the end spigot 3a of the drive spline 1. A punch tool comprising one or more axially projecting and radially arranged stepped or blunted punches in registration with the apertures 6 of the flange 5 is then used to press metal 8 from the inside end wall 22 of the clutch drum 21 through the minimally sized apertures 6 of the flange 5 forging the metal 8 into the shape of the counter sunk or counter bored portions 9 of the minimally sized apertures 6 abutting a die forming an enclosure.

Although the disclosed embodiments refer to a drive spline, it must be clearly understood that the same mechanical connection applies equally to any clutch drum assembly where it is desired to connect a clutch drum to a drive means either directly as in the case of a fixed drive sprockets or indirectly as in the case of a drive spline or drive shaft.

The embodiments have been described by way of example only and modifications are possible within the scope of the invention.

What is claimed is:

1. A clutch drum assembly comprising:
A clutch drum and drive means mounted thereon where the clutch drum defines an axis of rotation and includes an end wall forming one central aperture. The drive means may be a drive spline or a fixed drive sprocket. Axially to one end of the drive means is a flange with one or more radially spaced minimally sized apertures. A spigot on the splined or fixed drive sprocket side of the drive means flange is used for mating with the central aperture in the end wall of the clutch drum when the drive means is inserted through the end wall of the clutch drum. Upon mating of the two members, the assembly is mechanically connected for unitary axial rotation by metal pressed from the end wall of the clutch drum through each of the minimally sized apertures on the drive means flange.

2. The clutch drum assembly as in claim 1, where the radially spaced minimally sized apertures in the drive means flange are countersunk or counter bored to the opposite side of the drive means flange, that is proximate to the end wall of the clutch drum. The metal pushed from the end wall of the clutch drum through the minimally sized apertures on the drive means flange, is pressed against a die and forged into the shape of the counter sunk or counter bored portion of each minimally sized aperture proximate to the said die, forming a mechanical connection.

3. The clutch drum assembly as in claim 1, where the drive means is inserted into the clutch drum so that the drive means flange is flush with the inside wall of the clutch drum and the drive means spline or drive sprocket projects axially through the end wall opening of the clutch drum, or the drive means flange is centrally mated with the outside end wall of the clutch drum with the drive means spline or drive sprocket projecting axially outwards away for the clutch drum.

4. In a method of assembly the clutch drum assembly of claim 1, where the clutch drum and drive means are mechanically connected in a single step using a blunted or two step punch tool with an equal number of axial protrusions as there are minimally sized apertures in the drive means flange. The blunted or two step punch tool being used to press the clutch drum end wall metal through the minimally sized apertures in the drive means flange, and on passing through the minimally sized apertures, the clutch drum end wall metal expands to fill the counter bored or counter sunk portion which is of a greater size than the minimally sized apertures forming the mechanical connection.
